(19) United States
(12) Patent Application Publication
(10) Pub. No.: US 2010/0013389 A1
(43) Pub. Date: Jan. 21, 2010

(54) METAL HALIDE LAMP HAVING A DISCHARGE VESSEL SURROUNDED BY AN OUTER ENVELOPE

(75) Inventors: Tom Mathieu Julien Staut, Turnhout (BE); Catharina Johanna Maria Daemen, Eindhoven (NL); Alan Prest, Turnhout (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,709

(22) PCT Filed: Oct. 9, 2007
(86) PCT No.: PCT/IB2007/054097

§ 371 Date: Apr. 8, 2009

(30) Foreign Application Priority Data
Oct. 11, 2006 (EP) 06122073.7

(51) Int. Cl. H01J 61/36

(52) U.S. Cl. 313/623

(57) ABSTRACT

A metal halide lamp comprising a discharge vessel (10) having a translucent ceramic wall enclosing a discharge space (11). The vessel (10) has a cylindrical shape having its largest outer diameter in its central part (12). Two coaxial electrodes (15,16) are embedded in the end parts (13,14) of the vessel (10). The lamp furthermore comprises an outer envelope (5) surrounding the discharge vessel (10), and a current conductor (20) is present between the discharge vessel (10) and the wall (22) of the outer envelope (5). The current conductor (20) is provided with a support member (21) having a contact surface for abutting against the discharge vessel (10).

### FIELD OF THE INVENTION

The invention is related to a metal halide lamp comprising a discharge vessel having a translucent ceramic wall enclosing a discharge space, which vessel has a cylindrical shape having its largest outer diameter in its central part and having a smaller outer diameter at both coaxial end parts, two coaxial electrodes being embedded in said end parts of the vessel in order to extend into the discharge space and define a discharge path between their ends, the lamp furthermore comprising an outer envelope surrounding the discharge vessel, and a current conductor being present between the discharge vessel and the wall of the outer envelope in order to supply electric power to one of the electrodes.

By a cylindrical shape of the discharge vessel is meant a round (circular) shape, of which the diameter may vary over the length of the vessel and the two end parts each surround one of the two coaxial electrodes as well as further electrical conducting means for supplying electric power to one of the respective electrodes. The ceramic material of the vessel is metal oxide such as, for example, sapphire or densely sintered polycrystalline Al₂O₃, or metal nitride, for example, AlN. The electrical conducting means are, for example, niobium wires having substantially the same coefficient of thermal expansion as the material of the discharge vessel in order to prevent leakage of the discharge vessel.

### BACKGROUND OF THE INVENTION

Such a metal halide lamp is, for example, described in WO-A-2005/088675, where the discharge space is filled with a filling comprising an inert gas, such as xenon (Xe) and an ionizable salt. Said publication shows a discharge vessel with a cylindrical shape, of which the outer diameter is constant in its central part and the outer diameter of both end parts is smaller, but also constant over their lengths. The publication shows also a discharge vessel with a cylindrical shape, of which the outer diameter of the central part of the discharge vessel varies such that the largest outer diameter is present in the middle of the central part of the discharge vessel.

In practice, it has been found that rupture of the discharge vessel may occur, in particular when the largest outer diameter of the discharge vessel is relatively large. Such rupture of the discharge vessel inside the outer envelope will result in failure of the lamp.

### SUMMARY OF THE INVENTION

An object of the invention is a metal halide lamp comprising a discharge vessel of a substantially cylindrical shape having its largest outer diameter in its central part and having a smaller outer diameter at both end parts, the lamp furthermore comprising a transparent or translucent outer envelope surrounding the discharge vessel, and a current conductor being present between the discharge vessel and the wall of the outer envelope, which lamp is not subject to rupture of the discharge vessel.

To accomplish said object, said current conductor for supplying electric power to one of the electrodes is provided with a support member having a contact surface for abutting against the discharge vessel at a distance from the location where the discharge vessel has its largest outer diameter.

It has been found that rupture of the discharge vessel may occur if the current conductor is too close to the wall of the central part of the vessel or contacts said central part. Therefore, failure of the lamp due to rupture of the discharge vessel is avoided by preventing the current conductor from being too close to or contacting the central part of the discharge vessel. By means of said support member, the distance between the current conductor and the discharge vessel is always larger than a predetermined minimal distance.

It is noted that EP-A-0967631 discloses a metal halide lamp wherein the current conductor is provided with a starting aid comprising an electrically conductive wire surrounding a capillary of the discharge space, which capillary extends in each of the end parts of the discharge vessel. The starting aid provides a capacitively coupled ionization mechanism for starting the lamp. In case such an electrically conductive wire is made of a rigid wire and is firmly wound around the discharge vessel, a certain positioning of the current conductor may be obtained. However, such a starting aid is a wire that is wound around the discharge vessel, and it is not a support member that can abut or rest against it so as to prevent the current conductor from approaching the discharge vessel too closely.

The support member may only contact the discharge vessel in case the current conductor moves in the direction of the discharge vessel. However, in a preferred embodiment, the contact surface is continuously in contact with the discharge vessel in such a manner that it abuts against the discharge vessel by means of a force exerted by the current conductor. Thereby, a firm positioning of the current conductor is obtained.

In a preferred embodiment, the support member contacts the discharge vessel at a location where the diameter of the discharge vessel is constant over a part of its length. Thereby, a predetermined positioning of the current conductor is achieved, while the position of the support member may vary a little in the longitudinal direction of the lamp. Such variation in position is for instance due to differences in thermal expansion between the discharge vessel and the current conductor.

The weakest portion of the discharge vessel is in the central area of it. In general, the further away from the largest diameter of the discharge vessel, the smaller the chance that contact with the current conductor results in lamp failure. However, preferably, the support member contacts the discharge vessel at an end part, in particular where the electrode is embedded in the ceramic material of the discharge vessel. That portion of the discharge vessel is the best location for contact between the support member and the discharge vessel, i.e. the location with the best chance of avoiding lamp failure.

In a preferred embodiment, the contact surface of the support member has a smaller dimension in the longitudinal direction of the discharge vessel than in a direction perpendicular to that longitudinal direction. As a result, the positioning of the support member with respect to the discharge vessel is less critical, because small variations in transverse direction will not influence the position of the current conductor.

Preferably, the support member consists of a rigid wire having an end portion being curved so as to extend perpendicularly to a plane through the current conductor and the central axis of the discharge vessel. Such a curved wire is a simple and effective part of the lamp that can be welded to the current conductor.

### BRIEF DESCRIPTION OF THE DRAWINGS

The invention will now be further elucidated by means of a description of an embodiment of a metal halide lamp, wherein reference is made to the drawing comprising the following two schematic representations of the lamp:

FIG. 1 is a cross section of the metal halide lamp; and

FIG. 2 is a cross section according to line II-II in FIG. 1.

### DETAILED DESCRIPTION OF THE EMBODIMENTS

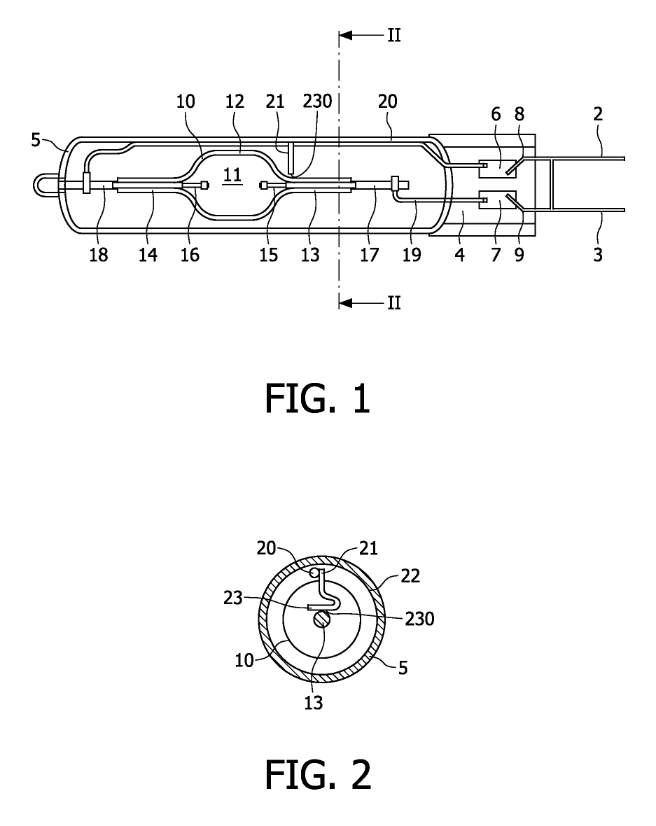

FIG. 1 shows a sectional view of the metal halide lamp having two electrical contact members 2,3 for engaging corresponding contact elements of a lamp holder (not shown). The two contact members 2,3 are embedded in the pinch portion 4 of the transparent outer envelope 5 of the lamp. Two molybdenum foils 6,7 are also embedded in the pinch portion 4 and are connected through lead wires 8,9 with the two contact members 2,3.

Inside the outer envelope 5 is a translucent discharge vessel 10 enclosing a discharge space 11. The discharge vessel 10 has a cylindrical shape, and the ceramic wall of the discharge vessel 10 has a relatively large diameter in its central part 12. Both end parts 13,14 of the discharge vessel 10 have a relatively small outer diameter, in which end parts 13,14 the two electrodes 15,16 are embedded. Each electrode 15,16 is connected with a current lead-through conductor 17,18, which conductor is embedded in an end part 13,14 of the discharge vessel 10 and extends outside the discharge vessel 10. Lead-through conductor 17 is connected with current conductor 19, which current conductor 19 is partly embedded in the pinch portion 4 of the outer envelope 5, where it is connected with molybdenum foil 7 in order to supply electric current from contact member 3 to electrode 15. Lead-through conductor 18 is connected with current conductor 20, which current conductor 20 is also partly embedded in the pinch portion 4, where it is connected with molybdenum foil 6.

In order to supply electric current from contact member 2 to electrode 16, current conductor 20 extends between the discharge vessel 10 and the wall of the outer envelope 5. A support member 21 is welded to current conductor 20 and extends towards the end part 13 of the discharge vessel 10 in order to prevent contact between the current conductor 20 and the central part 12 of the discharge vessel 10. The support member 21 has a contact surface 230 that rests against the end part 13, or the distance between the contact surface 230 of the support member 21 and the end part 13 of the discharge vessel 10 is smaller than the distance between the current conductor 20 and the central part 12 of the discharge vessel 10. Therefore, current conductor 20 will not contact the central part 12 in case the discharge vessel 10 or the current conductor 20 moves due to mechanical shocks or the like.

FIG. 2 is a sectional view according to the line II-II in FIG. 1. It shows the wall 22 of the transparent outer envelope 5 surrounding the discharge vessel 10. The current conductor 20 is located between the wall 22 and the discharge vessel 10. The support member 21 is welded to the current conductor 20. The support member 21 is a curved rigid wire, of which a straight portion 23 can rest with its contact surface 230 against the end part 13 of the discharge vessel 10.

As set forth above, the support member can abut against the end part 13 of the discharge vessel 10, or may be at a relatively small distance from the end part 13. The support member 21 may be a curved rigid wire or may have any other shape.

The embodiment as described above is only an example of a metal halide lamp according to the invention; many other embodiments are possible.

1. A metal halide lamp, comprising
a substantially cylindrical discharge vessel having a translucent ceramic wall enclosing a discharge space, the vessel having a central portion and a pair of coaxial end parts, the vessel having its largest outer diameter in said central part,
two coaxial electrodes embedded in said end parts of the vessel in order to extend into the discharge space and define a discharge path between their ends,
an outer envelope surrounding the discharge vessel, and
a current conductor disposed between the discharge vessel and the outer envelope in order to supply electric power to one of the electrodes, wherein said current conductor includes a support member having a contact surface for abutting against the discharge vessel at a distance from the location where the discharge vessel has its largest outer diameter.

2. A lamp as claimed in claim 1, wherein the contact surface abuts against the discharge vessel.

3. A lamp as claimed in claim 1, wherein the support member contacts the discharge vessel at a location where the diameter of the discharge vessel is constant over a part of the length thereof.

4. A lamp as claimed in claim 1, wherein the support member contacts the discharge vessel at an end part.

5. A lamp as claimed in claim 1, wherein the contact surface of the support member has a smaller dimension in the longitudinal direction of the discharge vessel than in a direction perpendicular to that longitudinal direction.

6. A lamp as claimed in claim 5, wherein the support member comprises a rigid wire having a straight end portion extending perpendicularly to a plane through the current conductor and the central axis of the discharge vessel.
